(19) United States
(12) Patent Application Publication
(10) Pub. No.: US 2018/0363373 A1
(43) Pub. Date: Dec. 20, 2018

(54) Roof Ladder System

(71) Applicant: James Anderson, Chillicothe, IL (US)

(72) Inventor: James Anderson, Chillicothe, IL (US)

(21) Appl. No.: 15/624,189

(22) Filed: Jun. 15, 2017

(51) Int. Cl. E06C 1/34; E06C 1/12; E06C 7/06

(52) U.S. Cl. CPC E06C 1/345; E06C 7/06; E06C 1/12

(57) ABSTRACT

A roof ladder system includes a building that has a roof. The roof has a first side, a second side and a peak. An extension ladder is provided and the extension ladder is selectively positioned on the first side of the roof thereby facilitating secure footing on the roof. A pair of arms is each hingedly coupled to the extension ladder. Each of the arms is positioned at a selected angle with respect to the extension ladder such that each of the arms is selectively positioned to match a pitch of the roof. Moreover, each of the arms is positioned on the second side of the roof thereby facilitating the extension ladder to be retained on the first side of the roof. An intersection between the arms and the extension ladder is positioned on the peak.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to ladder devices and more particularly pertains to a new ladder device for safely climbing on a pitched roof.

### BRIEF SUMMARY OF THE INVENTION

An embodiment of the disclosure meets the needs presented above by generally comprising a building that has a roof. The roof has a first side, a second side and a peak. An extension ladder is provided and the extension ladder is selectively positioned on the first side of the roof thereby facilitating secure footing on the roof. A pair of arms is each hingedly coupled to the extension ladder. Each of the arms is positioned at a selected angle with respect to the extension ladder such that each of the arms is selectively positioned to match a pitch of the roof. Moreover, each of the arms is positioned on the second side of the roof thereby facilitating the extension ladder to be retained on the first side of the roof. An intersection between the arms and the extension ladder is positioned on the peak.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a roof ladder system according to an embodiment of the disclosure.

FIG. 2 is a right side view of an embodiment of the disclosure.

FIG. 3 is a perspective in-use view of an embodiment of the disclosure.

FIG. 4 is a perspective view of an alternative embodiment of the disclosure.

FIG. 5 is a perspective view of first half of an embodiment of the disclosure.

### DETAILED DESCRIPTION OF THE INVENTION

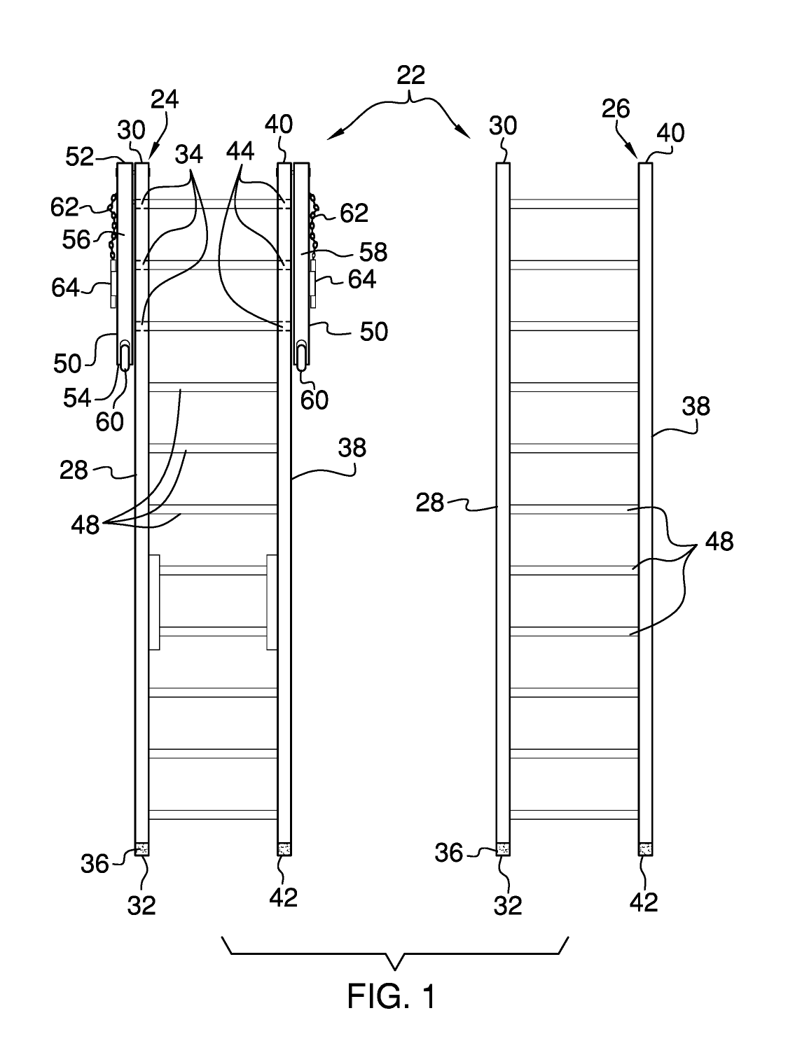

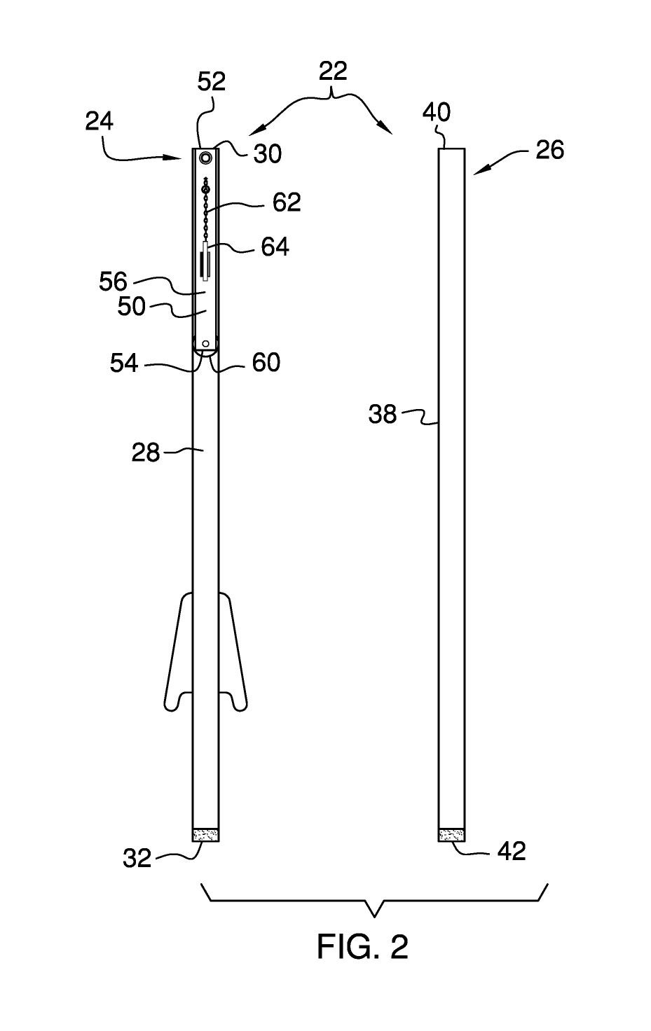

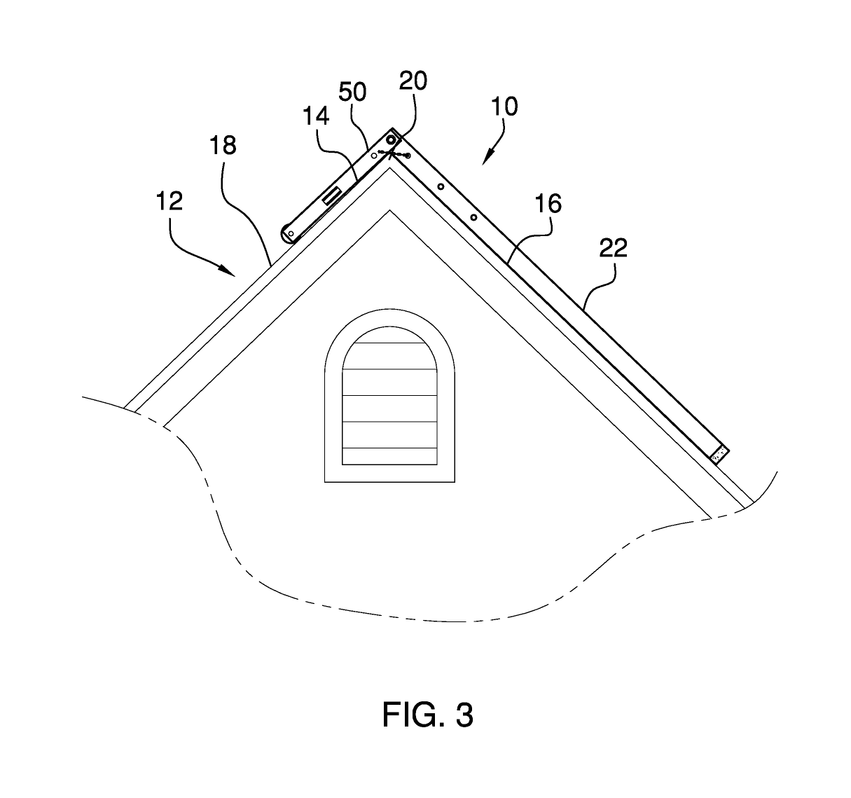

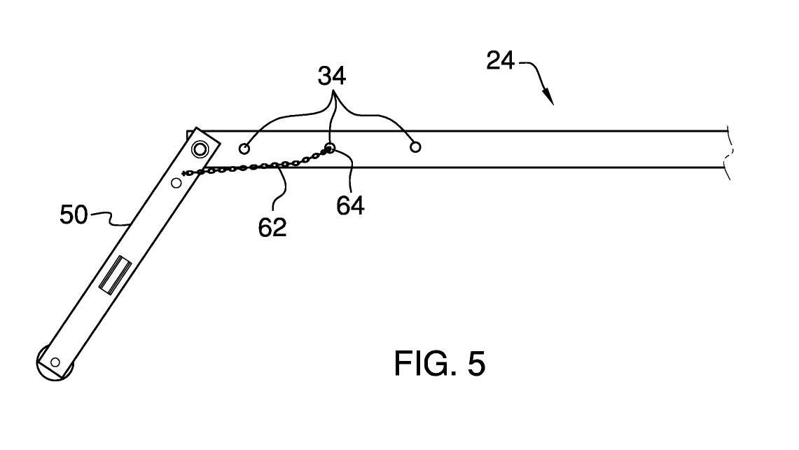

With reference now to the drawings, and in particular to FIGS. 1 through 5 thereof, a new ladder device embodying the principles and concepts of an embodiment of the disclosure and generally designated by the reference numeral 10 will be described.

As best illustrated in FIGS. 1 through 5, the roof ladder system 10 generally comprises a building 12 that has a roof 14 and the roof 14 has a first side 16, a second side 18 and a peak 20. The building 12 may be a house, a commercial building and any other building that has a pitched roof. An extension ladder 22 is provided and the extension ladder 22 is selectively positioned on the first side 16 of the roof 14. Thus, the extension ladder 22 facilitates secure footing on the roof 14. The extension ladder 22 includes a first half 24 that is slidably coupled to a second half 26 such that the extension ladder 22 is selectively positioned between a minimum length and a maximum length. Additionally, the first half 24 may be slidably coupled to the second half 26 through any conventional means with respect to extension ladders. The extension ladder 22 may be comprised of wood, aluminum, fiberglass and any other conventional material with respect to extension ladders.

Each of the first half 24 and the second half 26 comprises a first leg 28 that has a first end 30 and a second end 32. The first leg 28 corresponding to the first half 24 has a plurality of first apertures 34 extending therethrough. Moreover, the first apertures 34 are spaced apart from each other and are distributed from the first end 30 toward the second end 32. A first foot 36 is coupled to the second end 32 of the first leg 28 to selectively engage a support surface. The first foot 36 may be comprised of a resiliently compressible material such as rubber or the like.

Each of the first 24 and second 26 halves of the extension ladder 22 includes a second leg 38 that has a first end 40 and a second end 42. The second leg 38 corresponding to the first half 24 has a plurality of second apertures 44 extending therethrough. Moreover, the second apertures 44 are spaced apart from each other and are distributed from the first end 40 of the second leg 38 toward the second end 42 of the second leg 38. Each of the second apertures 44 is aligned with a corresponding one of the first apertures 34. A second foot 46 is coupled to the second end 42 of the second leg 38 to selectively engage the support surface. The second foot 46 may be comprised of a resiliently compressible material such as rubber or the like.

Each of the first 24 and second 26 halves includes a plurality of rungs 48. Each of the rungs 48 is coupled between the first 28 and second 38 legs such that the first 28 and second 38 legs are spaced apart from each other. Additionally, the rungs 48 are spaced apart from each other and are distributed between the first 30,40 and second 32,42 ends corresponding to each of the first 24 and second 38 legs. Each of the first 24 and second 38 legs corresponding to the first half 24 of the extension ladder 22 is slidably coupled to associated ones of the first 24 and second 38 legs corresponding to the second half 26 of the extension ladder 22. Additionally, the first half 24 is oriented collinear with the second half 26.

A pair of arms 50 is provided and each of the arms 50 is hingedly coupled to the extension ladder 22. Each of the arms 50 is positioned at a selected angle with respect to the extension ladder 22. In this way each of the arms 50 and the extension ladder 22 is selectively positioned to match a pitch of the roof 14. Moreover, each of the arms 50 is positioned on the second side 18 of the roof 14 thereby facilitating the extension ladder 22 to be retained on the first side 16 of the roof 14. An intersection between the arms 50 and the extension ladder 22 is positioned on the peak 20 of the roof 14.

Each of the arms 50 has a primary end 52 and a secondary end 54 and the pair of arms 50 includes a first arm 56 and a second arm 58. The primary end 52 of the first arm 56 is hingedly coupled to the first end 30 of the first leg 28 corresponding to the first half 24 of the extension ladder 22. The primary end 52 of the second arm 58 is hingedly coupled to the first end 40 of the second leg 38 corresponding to the first half 24 of the extension ladder 22. Additionally, each of the first 56 and second 58 arms may have a length ranging between approximately 76.0 cm and 100.0 cm. Each of the first 56 and second 58 arms includes a wheel 60 that is rotatably coupled to the secondary end 54. Additionally, each of the first 56 and second 58 arms includes a chain 62 is coupled to the arm and a pin 64 that is coupled to the chain 62.

The pin 64 corresponding to the first arm 56 is selectively positioned in a selected one of the first apertures 34 in the first leg 28 corresponding to the first half 24 of the extension ladder 22. In this way the first arm 56 is retained at a selected angle with respect to the first half 24. The pin 64 corresponding to the second arm 58 is selectively positioned in a selected one of the second apertures 44 in the second leg 38 corresponding to the first half 24 of the extension ladder 22. In this way the second arm 58 is retained at a selected angle with respect to the first half 24. Each of the arms 50 is oriented collinear with the first 28 and second 38 legs corresponding to the first half 24 when the pin 64 is removed from the corresponding first 34 and second 44 apertures. In this way the extension ladder 22 may be employed in the traditional convention of extension ladders.

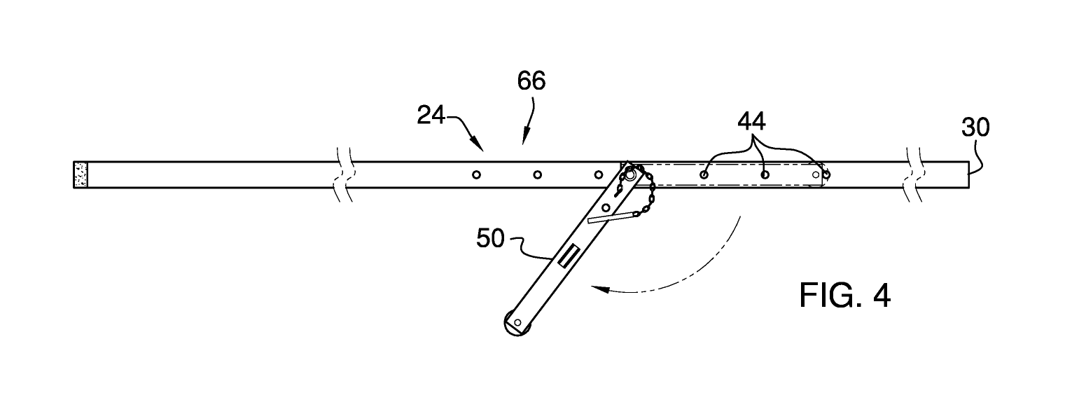

Each of the first 56 and second 58 arms may include a clip that is coupled to the arm. The clip may comprise a pair of spaced members and the pin 64 may be positioned between the spaced members for storage. The first half 24 of the extension ladder 22 may include a pair of stops that are each hingedly coupled an associated one of the first 24 and second 38 legs of the first half 24. Each of the stops may selectively engage a selected one of the rungs 48 on the second half 26. Thus, the extension ladder 22 is retained at a selected length. In an alternative embodiment 66 as shown in FIG. 4, each of the arms 50 may be spaced from the first end 30 corresponding to the first half 24 of the extension ladder 22.

In use, the pin 64 on each of the first 56 and second 58 arms is positioned in a selected one of the first 34 and second apertures 44. The pin 64 and the chain 62 on each of the arms 50 retain the arms 50 at a selected angle with respect to the extension ladder 22. Moreover, the selected angle corresponds to a pitch of the roof 14. The extension ladder 22 is positioned on the first side 16 of the roof 14 and the arms 50 are positioned on the second side 18 of the roof 14. Thus, the extension ladder 22 is retained on the first side 16 of the roof 14 when the rungs 48 are mounted thereby enhancing safety for climbing on the roof 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A roof ladder system comprising:
a building having a roof, said roof having a first side, a second side and a peak;
an extension ladder being selectively positioned on said first side of said roof thereby facilitating secure footing on said roof; and
a pair of arms, each of said arms being hingedly coupled to said extension ladder wherein each of said arms is configured to be manipulated, each of said arms being positioned at an angle with respect to said extension ladder such that each of said arms is selectively positioned to match a pitch of said roof wherein said each of said arms and said extension ladder lie flat against said roof extending away from said peak, each of said arms being positioned on said second side of said roof thereby facilitating said extension ladder to be retained on said first side of said roof having an intersection between said arms and said extension ladder being positioned in vertical alignment with said peak.

2. The system according to claim 1, wherein said extension ladder includes a first half and a second half.

3. The system according to claim 2, wherein each of said first half and said second half includes a first leg having a first end and a second end, said first leg corresponding to said first half having a plurality of first apertures extending therethrough, said first apertures being spaced apart from each other and being distributed from said first end toward said second end.

4. The system according to claim 3, wherein each of said first half and said second half includes a second leg having a first end and a second end, said second leg corresponding to said first half having a plurality of second apertures extending therethrough, said second apertures being spaced apart from each other and being distributed from said first end of said second leg toward said second end of said second leg, each of said second apertures being aligned with a corresponding one of said first apertures.

5. The system according to claim 4, wherein each of said first and second halves of said extension ladder includes
a plurality of rungs, each of said rungs being coupled between said first and second legs such that said first and second legs are spaced apart from each other, said rungs being spaced apart from each other and being distributed between said first and second ends corresponding to each of said first and second legs.

6. (canceled)

7. The system according to claim 5, wherein each of said arms has a primary end and a secondary end, said pair of arms including a first arm and a second arm, said primary end of said first arm being hingedly coupled to said first end of said first leg corresponding to said first half of said extension ladder, said primary end of said second arm being hingedly coupled to said first end of said second leg corresponding to said first half of said extension ladder.

8. The system according to claim 7, wherein each of said arms includes a wheel being rotatably coupled to said secondary end.

9. The system according to claim 7, wherein each of said arms includes a chain being coupled to said arm.

10. The system according to claim 9, further comprising:
a plurality of second apertures extending through said second leg corresponding to said first half of said extension ladder; and
a plurality of pins, each said pin being coupled to an associated one of said chains, said pin corresponding to said first arm being selectively positioned in a selected one of said first apertures such that said first arm is retained at said angle with respect to said first half, said pin corresponding to said second arm being selectively positioned in a selected one of said second apertures such that said second arm is retained at said angle with respect to said first half.

11. A roof ladder system comprising:
a building having a roof, said roof having a first side, a second side and a peak;
an extension ladder being selectively positioned on said first side of said roof thereby facilitating secure footing on said roof, said extension ladder including a first half and a second half, each of said first half and said second half comprising:
a first leg having a first end and a second end, said first leg corresponding to said first half having a plurality of first apertures extending therethrough, said first apertures being spaced apart from each other and being distributed from said first end toward said second end,
a first foot being coupled to said second end of said first leg wherein said first foot is configured to selectively engage a support surface,
a second leg having a first end and a second end, said second leg corresponding to said first half having a plurality of second apertures extending therethrough, said second apertures being spaced apart from each other and being distributed from said first end of said second leg toward said second end of said second leg, each of said second apertures being aligned with a corresponding one of said first apertures,
a second foot being coupled to said second end of said second leg wherein said second foot is configured to selectively engage the support surface, and
a plurality of rungs, each of said rungs being coupled between said first and second legs such that said first and second legs are spaced apart from each other, said rungs being spaced apart from each other and being distributed between said first and second ends corresponding to each of said first and second legs, and
a pair of arms, each of said arms being hingedly coupled to said extension ladder wherein each of said arms is configured to be manipulated, each of said arms being positioned at an angle with respect to said extension ladder such that each of said arms is selectively positioned to match a pitch of said roof wherein said each of said arms and said extension ladder lie flat against said roof extending away from said peak, each of said arms being positioned on said second side of said roof thereby facilitating said extension ladder to be retained on said first side of said roof having an intersection between said arms and said extension ladder being positioned in vertical alignment with said peak, each of said arms having a primary end and a secondary end, said pair of arms including a first arm and a second arm, said primary end of said first arm being hingedly coupled to said first end of said first leg corresponding to said first half of said extension ladder, said primary end of said second arm being hingedly coupled to said first end of said second leg corresponding to said first half of said extension ladder, each of said first and second arms including:
a wheel being rotatably coupled to said secondary end,
a chain being coupled to said arm, and
a pin being coupled to said chain, said pin corresponding to said first arm being selectively positioned in a selected one of said first apertures such that said first arm is retained at said angle with respect to said first half, said pin corresponding to said second arm being selectively positioned in a selected one of said second apertures such that said second arm is retained at said angle with respect to said first half.
